(19) United States
(12) Patent Application Publication
(10) Pub. No.: US 2004/0149883 A1
(43) Pub. Date: Aug. 5, 2004

(54) Automatic focusing method

(75) Inventor: Yukio Eda, Akiruno-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Olympus Optical Co., Ltd., Tokyo (JP)

(21) Appl. No.: 10/649,961

(22) Filed: Aug. 26, 2003

Related U.S. Application Data
(63) Continuation of application No. PCT/JP02/01841, filed on Feb. 28, 2002.

(30) Foreign Application Priority Data
Feb. 28, 2001 (JP) 2001-055604

(51) Int. Cl. G02B 7/04; G02B 27/40

(52) U.S. Cl. 250/201.3

(57) ABSTRACT

A method include scanning light from a light source which passes a confocal pattern on a sample through an objective lens while relatively moving one of the sample and the objective lens along a direction of an optical axis, acquiring two or more sectioning images by converting the light from the sample which penetrates the confocal pattern through the objective lens by a photoelectric converter, and changing an opening diameter of the variable diaphragm arranged at the pupil position of the objective lens or a conjugated position to the pupil position thereof to reduce a NA of the objective lens when focusing is not obtained and repeating an operation of taking two or more sectioning images by the photoelectric converter and obtaining the focusing position.

### CROSS-REFERENCE TO RELATED APPLICATIONS

This is a Continuation Application of PCT Application No. PCT/JP02/01841, filed Feb. 28, 2002, which was not published under PCT Article 21(2) in English.

This application is based upon and claims the benefit of priority from the prior Japanese Patent Application No. 2001-055604, filed Feb. 28, 2001, the entire contents of which are incorporated herein by reference.

### BACKGROUND OF THE INVENTION

1. Field of the Invention

The present invention relates to an automatic focusing method of automatically adjusting a focus in the confocal microscope.

2. Description of the Related Art

Recently, the number of electrodes of the LSI chips increases as high integration of the LSI. In addition, the packaging density of an LSI becomes high, too. The bump electrode has come to be adopted as an electrode of an LSI chip from such a background.

FIG. 1 is a figure which shows a schematic configuration of the LSI chip on which such a bump electrode is formed. Two or more hemisphere bumps 101 are formed on a LSI chip 100 as shown in FIG. 1. In this case, bumps 101 have various sizes and different pitches therebetween. For instance, bumps of radius 50 μm and pitch 200 μm, etc. are used. At this time, if the LSI chip 100 is 10 mm×10 mm, a great number of bumps having several thousand pieces of bumps are formed.

And, for the LSI chip 100 on which such bumps 101 are formed, so-called a flip-chip connection is performed. In the flip-chip connection, the LSI chip 100 is inversely contacted on the substrate 102 and bumps 101 are connected with electrodes (not shown in the figure) on the substrate 102.

In this case, it is important to accurately connect the electrodes (not shown in the figure) on the substrate 102 and bumps 101, naturally. Therefore, it is necessary to form the shape and the height of bumps 101 accurately.

As shown in FIG. 3, it is assumed that the bumps 101 on the LSI chip 100 have even height size at a height level shown by the dotted line in the design. However, there are higher bumps or lower bumps than the designed height thereof actually as a bump 101′ which is painted in black because of an error in manufacture etc. Therefore, if the flip-chip connection is performed for such the LSI chip 100, there is fear that contact failure to the substrate 102 occurs.

Therefore, the height of bumps 101 within the range of a predetermined difference should be used as the LSI chip 100 on which such bumps 101 are formed. From such a background, it is required that the heights of all bumps are in-line inspected by an accuracy of several μm before flip-chip connection.

Then, the height measurement apparatus using a confocal optical system has been considered (see Japanese Patent Application KOKAI Publication No. 9-113235 and Japanese Patent Application KOKAI Publication No. 9-126739). The laser scanning type and the disk type (Nipkow disk) are known as the confocal optical system in this case, and both of them have a function to convert light distribution of the height direction (optical axis direction) into the detection light quantity.

FIG. 4 is a figure which shows a principle of the above-mentioned confocal optical system. The light beam irradiated from a light source 211 condenses on a sample 215 through a pinhole 212, a beam splitter 213, and an objective lens 214. The light reflected with the sample 215 is condensed to the pinhole 216 through the objective lens 214 and the beam splitter 213, and is received with the optical detector 217 such as CCD. Here, it is assumed that the sample 215 is shifted by ΔZ in the direction of an optical axis. The light reflected with the sample 215 passes through the path of broken line shown in the figure and broadens greatly on the detection pinhole 216. Therefore, a light quantity which can pass the detection pinhole 216 becomes very small, and the passing light quantity therethrough is considered to be 0 substantially.

FIG. 5 is graph which shows a relationship (I-Z characteristic) between movement position in Z direction of the sample 215 and the light quantity I which passes the detection pinhole 216. Specifically, FIG. 5 is a figure which normalizes the relation between the position Z of the sample 215 based on the focus position when the numerical aperture (NA) of the objective lens 214 is assumed to be a parameter and the light quantity I by the maximum value. In FIG. 5, the light quantity I is largest (I=1) when the sample 215 is at focus position (Z=0), and the light quantity I decreases as parting from the focus position. Therefore, when the sample 215 is observed with the confocal optical system, only the vicinity of the focus position looks bright. This effect is called the sectioning effect of the confocal optical system. In a word, the overlapped image of the blur image in the part which shifts from the focus position and the image at the focusing position are observed in a usual optical microscope. However, the slice image only at the focusing position is observed by the sectioning effect in the confocal optical system. This is a point which is greatly different from the confocal optical system and usual optical microscope. The larger the NA of the objective lens 214 is, the more remarkable the sectioning effect is. For instance, only the slice image of the sample 215 of ±10 μm or less can be observed from the focus position when NA=0.3.

In the Japanese Patent Application KOKAI

Publication No. 9-113235, the height information is obtained as follows. The discrete sectioning image is acquired by using the I-Z characteristic of the confocal optical system. The quadric curve is approximated from three IZ data which contains the maximum brightness of each pixel. Then, the height information is obtained by presuming the IZ peak position. In a word, the curve fitting, for instance, the above-mentioned quadric curve approximation is performed by using the sectioning effect of the confocal optical system, and the height of the sample is measured according to the above-mentioned document. However, at least three sectioning images are necessary within the range more than predetermined strength in the IZ curve in this case. The reason to need three sectioning images is that the data of three points is necessary so that there are three unknown numbers when quadric curve approximation is performed.

In addition, three sectioning images should be images obtained more than predetermined strength in the IZ curve. The reason will be explained based on FIG. 6. FIG. 6 is a figure which shows an example of actually measuring the IZ curve of the objective lens of NA=0.3. As apparent from FIG. 6, the shape has fallen into disorder by the aberration of the objective lens in the lower end part of measurement IZ curve. Therefore, it is necessary to use the data of the part where the disorder of the IZ curve is negligible to perform the curve fitting. It can be considered that strength is about 0.4 or more in which the part where the disorder of the IZ curve is negligible. When assuming that the data with strength of 0.5 or more is adopted for easiness, to calculate the curve fitting in the area of strength of 0.5 or more, the predetermined minimum number of data points (three data points when the fitting is performed to the quadric curve) is needed. Therefore, the maximum value of the sampling intervals in the Z direction is limited. And, when full width of the IZ curve in the Z direction at strength of 0.5 is assumed to be W0.5, W0.5=8 μm. To acquire three data in W0.5=8 μm, the sampling interval in the Z direction should be 8 μm/3=2.67 μm at most roughly case. Therefore, the sampling interval in the Z direction cannot be made rougher than 2.67 μm in the IZ curve of FIG. 6.

When height is measured while performing the curve fitting as mentioned above, the sampling along Z direction cannot be performed more roughly than the limitation value from the above-mentioned limitation of the maximum value of the sampling intervals in the Z direction.

Accordingly, the following problems are caused.

For instance, when the bump height is inspected, the case where large measurement range is required even if the height measurement accuracy is somewhat sacrificed and does not want to increase the inspection time is considered. In this case, it is effective to make the sampling interval along the direction of Z rough not to increase the inspection time and to suppress the number of the acquisition sectioning images. However, there is the maximum value limitation in the Z direction of the sectioning image at sampling intervals as mentioned above. Therefore, it is necessary to increase the number of the sectioning images to correspond to the large height measurement range. As a result, the problem of increasing the bump height inspection time, and resulting the increase of the cost of the inspection a chip is caused.

It can be considered two or more objective lenses having different NAs are changed and used to solve this problem. However, the objective lens used for the bump height inspection, whose magnification is low (wide-field) and whose NA is large (NA=0.3 and NA=0.25, etc.), is large-scale and expensive. Additionally, the change mechanism of the objective lens becomes complex, too. Therefore, the problem of increasing the cost of the inspection for a chip in this case is caused.

### BRIEF SUMMARY OF THE INVENTION

An object of the present invention is to provide an automatic focusing method capable of reducing an inspection cost.

An automatic focusing method according to the first aspect of the present invention is characterized by comprising: scanning light from a light source which passes a confocal pattern on a sample through an objective lens while relatively moving one of the sample and the objective lens along a direction of an optical axis; acquiring two or more sectioning images by converting the light from the sample which penetrates the confocal pattern through the objective lens by photoelectric conversion means; and changing an opening diameter of the variable diaphragm arranged at the pupil position of the objective lens or a conjugated position to the pupil position thereof to reduce a NA of the objective lens when focusing is not obtained and repeating an operation of taking two or more sectioning images by the photoelectric conversion means and obtaining the focusing position.

An automatic focusing method according to the second aspect of the present invention is characterized by comprising: scanning the sample with light from a light from a light source which passed a confocal pattern while moving one of a sample and an objective lens along the direction of an optical axis at a predetermined sampling interval; acquiring two or more sectioning images by converting light from the sample which penetrates the confocal pattern through the objective lens by the photoelectric conversion means; obtaining a focusing position according to a predetermined function based on the plurality of sectioning images taken by the photoelectric conversion means; and changing an opening diameter of the variable diaphragm arranged at the pupil position of the objective lens or a conjugated position to the pupil position thereof to reduce a NA of the objective lens when focusing is not obtained and repeating an operation of taking two or more sectioning images by the photoelectric conversion means and obtaining the focusing position.

In the second aspect and the second aspect, the following modes are desirable. The following modes may be applied independently and can be applied by properly combining them.

(1) An objective lens with low magnification and high NA is used for the objective lens.

(2) Two or more sectioning images are taken without changing the predetermined sampling interval when the NA of the objective lens is changed.

(3) An operation to which the focusing position is obtained is repeated until three or more sectioning images are acquired.

(4) Whether the sectioning image uses data of a part where disorder is caused by an aberration of the objective lens is judged and the sectioning image is acquired by reducing the NA of the objective lens when the disordered data is used.

### BRIEF DESCRIPTION OF THE SEVERAL VIEWS OF THE DRAWING

FIG. 1 is a figure which shows a schematic configuration of the LSI chip on which bump electrodes are formed;

FIG. 2 is a figure which shows a connection state between the LSI chip and substrate;

FIG. 3 is a figure to explain a state of a defective bump;

FIG. 4 is a figure which shows a schematic configuration of a general confocal optical system;

FIG. 5 is a figure which shows an IZ curve with a parameter of NA;

FIG. 6 is a figure which shows a measured IZ curve of the objective lens;

FIG. 7 is a figure which shows a schematic configuration of the confocal microscope applied to the first embodiment of the present invention;

FIG. 8A and FIG. 8B are figures which show confocal image to the first embodiment;

FIG. 9 is a figure to explain the first embodiment;

FIG. 10 is a figure which shows one example of the variable diaphragm;

FIG. 11 is a figure which shows one example of the variable diaphragm;

FIG. 12 is a figure which shows one example of the variable diaphragm;

FIG. 13 is a figure which shows one example of the variable diaphragm;

FIG. 14 is a figure which shows a schematic configuration of the second embodiment of the present invention;

FIG. 15 is a figure which shows an example of applying the present invention to laser scanning microscope;

FIG. 16 is a flow chart to explain the focusing operation according to the fourth embodiment; and

FIG. 17A to FIG. 17C are figures to explain the confocal disk used for the third embodiment of the present invention.

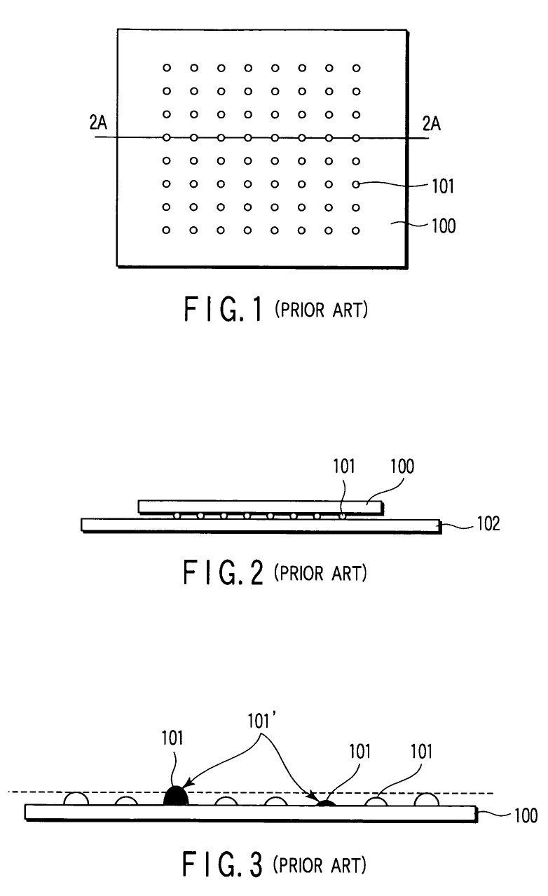

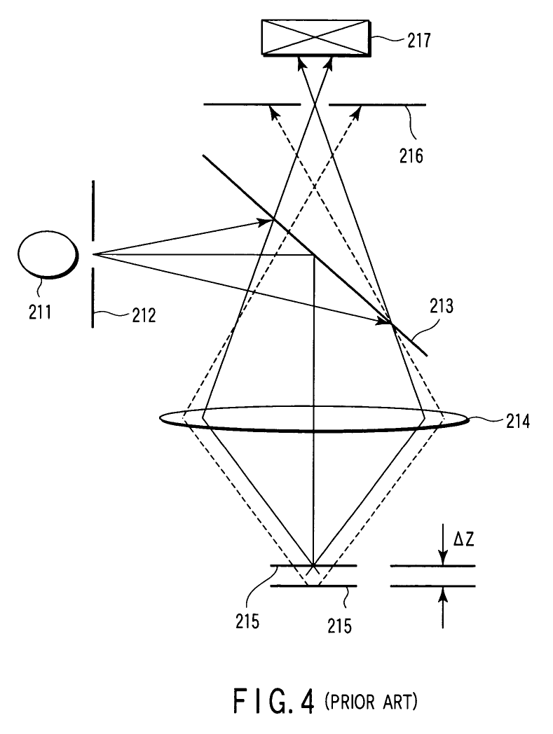

### DETAILED DESCRIPTION OF THE INVENTION

Hereinafter, embodiments of the present invention will be explained referring to the drawings.

(First Embodiment)

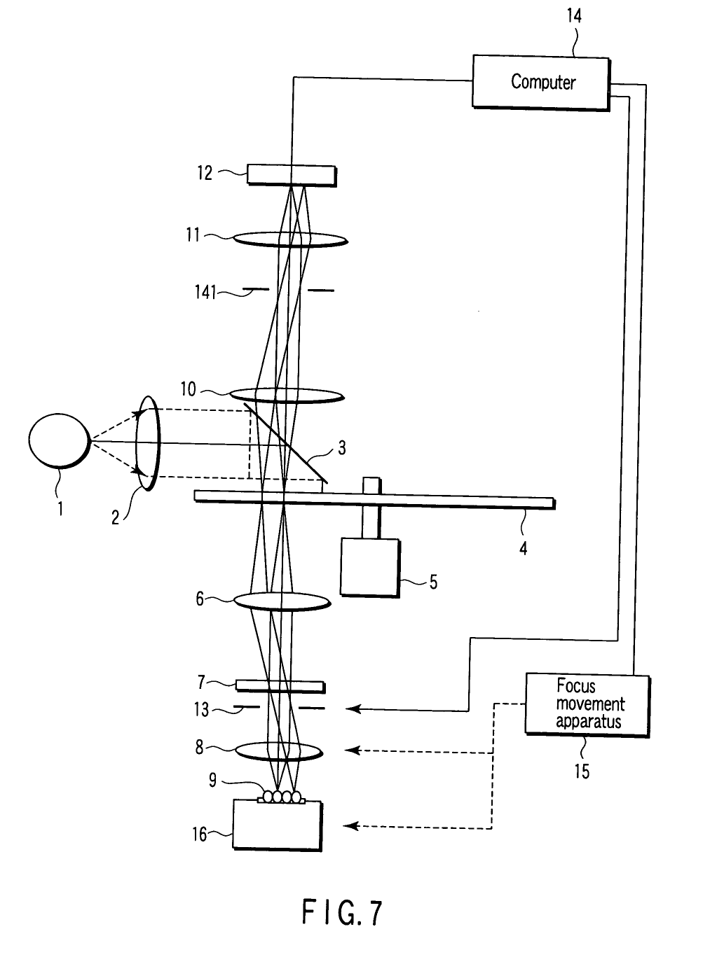

FIG. 7 is a figure which shows a schematic configuration of the confocal microscope to which the first embodiment of the present invention is applied.

In FIG. 7, a light source 1, a lens 2 which forms a illumination optical system and a PBS 3 (polarized beam splitter) are arranged on a optical path of a light beam which is emitted from the light source 1 having a halogen light source or a mercury light source, etc. A sample 9 is arranged on a reflection optical path of the PBS 3, through, for instance, a the confocal disk 4 such as Nipkow disk etc., a tube lens 6, a ¼ wavelength plate 7, a variable diaphragms 13, and an objective lens 8. These configure a first image formation optical system having a sectioning effect. A variable diaphragm 13 is arranged at a pupil position of the objective lens 8. As described later in detail, a vane diaphragm which can vary the diameter, or a fixed diaphragm which can selectively exchange two or more openings with different diameters on an optical axis (In the specification, called “variable diaphragm” containing all of kinds of diaphragms) is used as variable diaphragm 13. In the example shown in FIG. 7, the vane diaphragm that the diaphragm diameter is controlled with stepless by the instruction from the computer 14 described later is used. Moreover, on the transmission optical path of the PBS 3 of the reflection light from the sample 9, the CCD camera 12 is arranged parallel to the first image formation optical system through the lens 10, the diaphragm 141 and the lens 11 which configure the second image formation optical system.

In the Nipkow disk used as the confocal disk 4, the pinholes are arranged on a circular plate (disk) in a spiral form, and the distance of each pinhole is about ten times the diameter of the pinhole. The confocal disk 4 is connected with the axis of the motor 5, and is rotated at a constant rotation speed. The confocal disk 4 may be a Tony Wilson disk disclosed in the international publication No. 97/31282 etc. and a line pattern disk, on which the straight transmission patterns and the straight shielding patterns are alternately formed, if the sectioning effect be obtained. The confocal disk 4 is not limited to a disk in which the pattern is formed with a thin film on the glass disk, and the transmission liquid crystal display, which can make a confocal pattern an image may be used as the confocal disk 4. Hemisphere bumps are formed on LSI chip in the sample 9, and the sample 9 is put on the sample stage 16.

The computer 14 is connected with the CCD camera 12. Starting and ending the imaging in the CCD camera 12, and transfer of the imaged image etc. are controlled by the instruction from the computer 14. The computer 14 takes the image data imaged by the CCD camera 12 and performs operation processing and displays it on the monitor (not shown in the figure). In addition, the computer 14 gives a driving instruction to the focus movement apparatus 15. The focus movement apparatus 15 moves the sample stage 16 or the objective lens 8 along the direction of an optical axis according to the driving instruction of the computer 14 and acquires two or more images.

With such a configuration, the light beam emitted from the light source 1 becomes a parallel light beam through the lens 2. The parallel light beam is reflected with the PBS 3. The light beam reflected with the PBS 3 is incident to the confocal disk 4 which rotates at a constant speed. The light beam passing through the pinhole of the confocal disk 4 passes the tube lens 6, and becomes a circular polarized light beam by the ¼ wavelength plate 7. The circular polarized light beam is image-formed by the objective lens 8, through the variable diaphragm 13 and is incident to the sample 9. The direction of the light reflected from the sample 9 becomes a polarized light direction orthogonal to the incident light beam by the ¼ wavelength plate 7 through the objective lens 8 and the variable diaphragm 13. And, the sample image is projected on the confocal disk 4 by the tube lens 6. And, the focused part of the sample image projected on the confocal disk 4 passé the pinhole on the confocal disk 4, furthermore, transmits the PBS 3 and is imaged by the CCD camera 12 through the lens 10, the diaphragm 141, and the lens 11. The confocal image imaged by the CCD camera 12 is taken into the computer 14, and displayed on the monitor (not shown in the figure).

Here, FIG. 7 shows light, which passed two pinholes among two or more pinholes on the confocal disk 4 for easiness. The pinhole of the confocal disk 4 and the focal plane of the objective lens 8 are conjugate, and the tube lens 6, the objective lens 8 and the variable diaphragm 13 are arranged in the both sides telecentric system. In addition, the light source 1 and the variable diaphragm 13 are in the conjugate relation, and configure the Koehler illumination which can illuminate the sample 9 uniformly. The height distribution along the direction of an optical axis of the sample 9 can be converted into the optical strength information by the above-mentioned first image formation optical system by using the I-Z characteristic of the confocal optical system. As mentioned before, the variable diaphragm 13 is a variable diaphragm or an exchangeable diaphragm. The variable diaphragm 13 is the most important element for the present invention as explained later in detail.

On the other hand, the confocal disk 4 and the CCD camera 12 are in the conjugate relation by the lenses 10 and 11, and the second image formation optical system which consist of the lenses 10, 11 and the CCD camera 12 has the arrangement of the both sides telecentric system according to the existence of the diaphragm 141. This second image formation optical system may not be telecentric. However, if the length of the second image formation optical system is negligible, the telecentric system, which hardly reduces the ambient light quantity, is preferable.

The CCD camera 12 images the sectioning image only in the vicinity of the focal plane of the objective lens 8 by such the first image formation optical system and the second image formation optical system. Only the focal plane looks bright and the part which shifts from the focal plane along the direction of an optical axis looks dark when the imaged sectioning image is displayed on the monitor. And, three-dimensional information on the sample 9 can be obtained, if two or more images are acquired by moving the sample stage 16 or the objective lens 8 along the direction of an optical axis with focus movement apparatus 15. The range of the measurement of XY in this case is a range the imaging view in the CCD camera 12 and the range of Z measurement is a range where the sectioning image have been imaged by moving the focus.

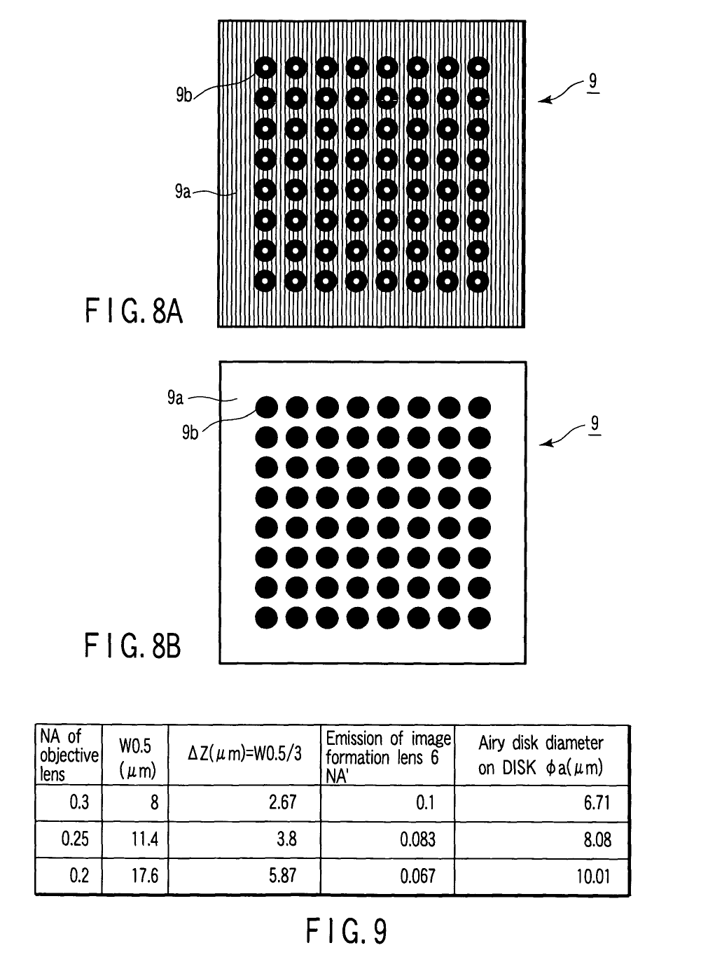

Next, the appearance when a lot of bumps 9b formed on the LSI chip 9a are observed will be explained as the sample 9 by FIG. 8A and FIG. 8B.

First, FIG. 8A is a confocal image when in the vicinity of the top of bump 9b on LSI chip 9a is focused. The image with a bright only this part of bump 9b, in a word, vicinity of the top can be observed when an open bright area shown at the center of bumps 9b in FIG. 8A is φ. In FIG. 8A, it is shown that the density in the black paint part of the LSI chip 9a and the bumps 9b is different for explanation, but actually the bright part is the vicinity of the tops of the bumps 9b and the part except the bright part is most pitch-dark.

The vicinity of the top of bump 9b darkens gradually by the sectioning effect of the confocal optical system when the focusing position is brought close from this state to the LSI chip 9a surface. Then, the bump 9b will become pitch-dark. The LSI chip 9a surface becomes bright gradually when the focusing position is brought close to the LSI chip 9a surface. The bump 9b becomes most pitch-dark and the LSI chip 9a surface becomes brightest as shown in FIG. 8B, in a state of focusing to the LSI chip 9a surface.

Actually, since the images shown in FIG. 8A and FIG. 8B are imaged by the CCD camera 12, the case of this imaging will be considered. The pixel size of the CCD used for the CCD camera 12 is usually about several μm to 10 μm. When the pixel size of CCD is assumed to be 10 μm square pixel for easiness, the CCD size of 1000×1000 (1,000,000 pixels) which can be easily purchased in the price is 10×10 mm. As a result, if the magnification of the whole optical system is one, the sample 9 of 10×10 mm can be observed at a time. It is necessary to achieve the wide-field optical system, in which the magnification of the whole optical system is one, to achieve a high-speed inspection. However, in this case, the combination, such that the magnification of the first image formation optical system is 3 and the magnification of the second image formation optical system is ⅓ times, may be considered, and in practical use, the whole magnification may set to twice or to the reduction system of ½ times etc.

Next, the sampling interval ΔZ along the Z direction where the sectioning image by the sectioning effect decided by the NA of the first image formation optical system is acquired will be explained.

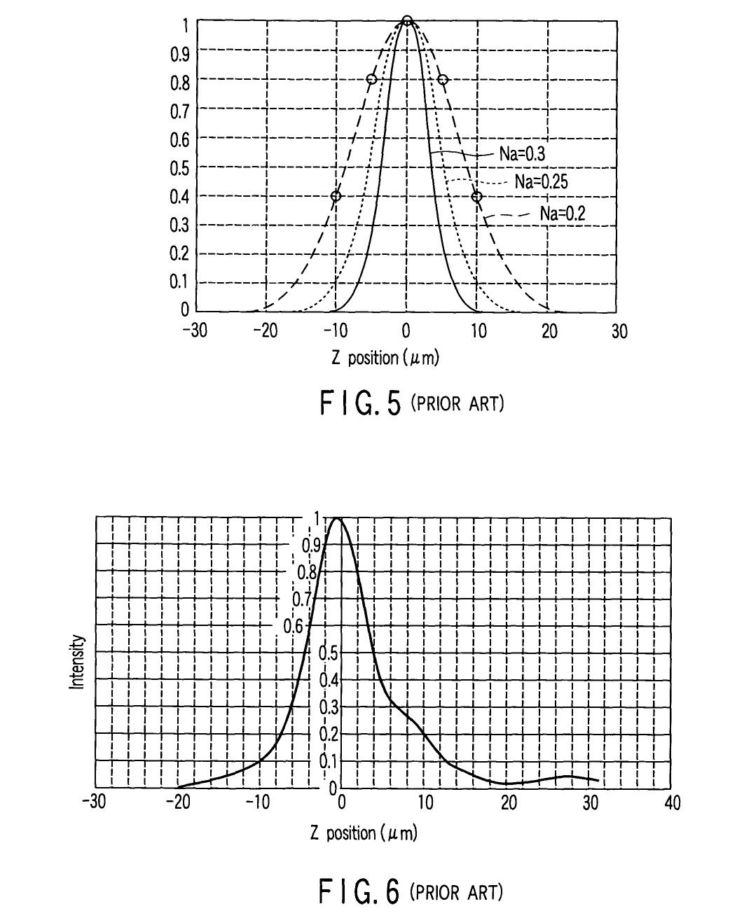

By the way, the sectioning effect, that is, steepness of the IZ curve is decided by the NA as shown in FIG. 5. In FIG. 5, three theory IZ curves whose NAs are 0.3, 0.25, and 0.2 are shown. Here, the reason to show the IZ curve of such NA is why it is expected that the objective lens with largest NA which is considered to be able to put to practical use is about NA=0.3 when the magnification of the first image formation optical system is low magnification of about three times. When NA becomes small such as 0.25 and 0.2 etc., difficulties of the design and production are more eased. However, the objective lens 8 becomes expensive and large-scale since the objective lens 8 has high NA regardless of low magnification.

Next, a case to measure height will be explained by actually using the objective lens 8 of about NA=0.3. In this case, since FIG. 5 shows the theory IZ curve, the IZ curve is completely symmetric for the focus position (Z=0 μm). However, in the IZ curve of the objective lens 8 of actual NA=0.3, a part of lower end thereof falls into disorder by the aberration as shown in FIG. 6. Therefore, when the sectioning image is discretely sampled from the IZ curve with ΔZ in the Z direction and is fitted by the quadric curve and/or the Gauss distribution curve., and Z at the peak position thereof is obtained as the height information of the bump, to improve the measurement accuracy, it is necessary not to use the data of the lower end part where disorder is caused by the aberration. At the fitting, a theoretical IZ curve (format of (sin(x)/x)²) can be approximated considerably well by Gauss distribution curve (exp(−(x−a)²/2×σ², σ is standard deviation, a is average value). Therefore, the Gauss fitting is more advantageous than the quadric curve. Moreover, since the Gauss fitting is treated as the quadric curve if a natural logarithm is applied thereto, the calculation is not annoyed too much.

It is undesirable to use data which greatly parts from the focus position and is dark for fitting even if an S/N of the CCD quantum noise (∝½(brightness)) etc, is considered. From such a reason, it is desirable to assume the data of predetermined threshold Ith or more to be valid and to assume the data of threshold Ith or less to be invalid. At least three data of threshold Ith or more is needed mathematically in either of a Gauss or the quadric curve fitting. The number of minimum necessary data is the same as the number of coefficients, which is included in the function used for the fitting. However, with the above-mentioned reason, it can be considered that the Gauss distribution is sufficient as the function used for the fitting. Therefore, the Gauss distribution is assumed to be used in the following explanation. However, the scope of the present invention does not change since the explained is performed by the Gauss distribution.

The threshold Ith may be determined and selected properly by judging S/N of the image and the disorder of the lower end of the IZ curve of the objective lens 8 to be used etc. Here, it is assumed as Ith=0.5 based on the disorder of the measurement IZ data of FIG. 6. Actually, since theoretical IZ in FIG. 5 and measured IZ in FIG. 6 at NA=0.3 are corresponding very well up to about 0.4, Ith=0.5 is appropriate.

The full width W0.5 along the direction of Z at Ith=0.5 of measured IZ in FIG. 6 is 8 μm. Therefore, sampling interval ΔZ along the Z direction so that three discrete IZ data or more is exist therein becomes ΔZ=8 μm/3=2.67 μm. And, if the fitting is performed by reducing the sampling interval ΔZ less than 2.67 μm and always using four data or more, the inspection time becomes long. However, accuracy at the peak presumption position can be more improved. This mode will be called as “high accurate inspection mode”. Actually, when the discrete IZ data is acquired with ΔZ=2.67 μm and the fitting is performed, the height measurement accuracy can be suppressed about within a range of ±1 μm.

On the other hand, it is forecast that bumps having a variety of kind of the size and the shape will be produced in the future. It is forecast that the inspection range of the height of the bump broadens along with this, too. For instance, the height of the bump from the LSI chip surface is about 50 μm even in the small bump up to now. However, the one of height of about 10 to 20 μm is being put to practical use recently. In this case, generally, the height inspection with high accuracy is required in a smaller bump. Oppositely, the height inspection accuracy is not required in a large bump compared with the small bump. The height inspection accuracy of about 1/20 of the height of the bump might be required from the user request.

The small bump is inspected by the high accurate inspection mode mentioned above, but the large bump is inspected as follows.

A case where the bump of the size of 50 μm in height is inspected is considered as an example. In this case, the required inspection accuracy becomes ±5 μm by 1/20 of 100 μm. When the NA of the objective lens 8 is to be NA=0.3 as well as the above-mentioned description, the sampling interval ΔZ along the direction of Z is 3.37 μm even if it is the roughest interval. There is no problem in accuracy because this value sufficiently satisfies the required accuracy. However, since the above value of ΔZ is over specs, the problem of having uselessly spent the inspection time is caused as inspection apparatus. In a word, a useless cost is necessary to the cost to inspect a chip. It is required to reduce the cost of the inspection for one chip as inspection apparatus by shortening the inspection time as much as possible with a necessary enough inspection accuracy.

To meet the change in the range of such a height measurement, a method of preparing two or more objective lenses 8 whose NAs are different and exchanging exchange the objective lens 8 with optimal NA to be able to select steep of the IZ curve according to the measurement range. The objective lens 8 used in the bump inspection is expensive and large as mentioned above. Therefore, the problem in the cost occurs. When an electric revolver mechanism is prepared to change the objective lens automatically, since the objective lens 8 is large-scale, an electric revolver mechanism becomes large and complex. The cost required. In addition, since the revolver mechanism has the lower rigidity in the configuration, the revolver mechanism is influenced easily by the turbulence such as the vibrations and the measurement accuracy degrades, too.

Then, in the present invention, only one objective lens 8 with low magnification and high NA is fixedly arranged on the optical axis and the NA of the objective lens is changed by changing the aperture diameter of the variable diaphragm 13 based on the instruction from the computer 14. As a result, two or more IZ curves can be selected by low-cost in a very simple configuration. In a word, if the diameter of the variable diaphragm 13 is adjusted to 1/1.2, NA becomes 0.25 when assuming NA is 0.3 when the variable diaphragm 13 is the maximum diameter. If the diameter of the variable diaphragm 13 is adjusted to ⅔, NA becomes 0.2. Thus, an equivalent result as in the case of the exchange to the objective lens 8 with optimal NA by varying the condition to obtain the sectioning image.

In this case, FIG. 9 shows the relationship between Ith=0.5 of the IZ curve, the Z sampling interval ΔZ to obtain at least three data in W0.5, emit NA′ at disk from the tube lens 6 and the Airy disk diameter φa on the confocal disk 4, for NA (0.3, 0.25, 0.2) of the objective lens. In this case, the magnification of the first optical system is assumed to be three, NA′=NA/3, φa=1.22×NA′/λ, and λ=0.55 μm in the light wave length.

Therefore, in FIG. 9, for instance, when the Z sample intervals ΔZ in NA=0.3 to obtain at least three data in W0.5 is compared with that in NA=0.2, ΔZ becomes ΔZ=2.67 in NA=0.3 and ΔZ becomes ΔZ=5.87 in NA=0.2, therefore, ΔZ in NA=0.2 is twice or more of ΔZ in NA=0.3. That is, since ratio of ΔZ in NA=0.2 and ΔZ in NA=0.3 is 5.87/2.67=2.2, in a case of ΔZ in NA=0.2, the sampling with twice or more roughly intervals can be performed comparing a case of ΔZ in NA=0.3. As a result, it becomes possible to control an increase of the measurement time by the measurement range expansion.

In an ideal confocal optical system, the pinhole of confocal disk 4 is an infinitely small but the penetration light vanishes, therefore the pinhole is set to Airy disk diameter φa or less on the confocal disk 4. Actually, the pinhole is often designed by about ⅔ of φa considering S/N. When the NA is changed by the variable diaphragm 13, the optimal pinhole diameter of the confocal disk 4 changes strictly, too, and it becomes necessary to exchange the disk. To avoid this, the confocal disk 4 can be used commonly even in a case of NA=0.25 and NA=0.2 by setting the pinhole diameter to φa×⅔=6.71×⅔=4.5 μm in NA=0.3. However, the image darkens since Airy disk diameter φa on the confocal disk 4 becomes large when the NA becomes small in this case. The light quantity of the light source 1 is adjusted to become the optimal brightness corresponding to the NA when the NA of the objective lens 8 is changed. A case of reducing the NA is a case of measuring a large range, that is, large bump. In such a condition, the top image of the bump imaged by the CCD camera 12 also becomes large, and the total detection light quantity increases. Therefore, the effect of complementing the decrease of the light quantity by the reduction of NA can be obtained.

Therefore, the NA of the optimal objective lens 8 for height measurement can be selected by varying the diaphragm diameter of the variable diaphragm 13 according to the first mode. Therefore, with only one the apparatus, it becomes possible to correspond shortening the inspection time as much as possible for the various requests of request which wants to be measured in high accuracy at the expense of the Z measurement range, request of enlarging the Z measurement range at the expense of accuracy, or request of regarding the speed-up of the inspection time at the expense of accuracy under a necessary enough inspection accuracy. As a result, the inspection cost for a chip can be reduced. In addition, since only one objective lens 8 is required, the apparatus cost can be greatly reduced. Moreover, since no the revolver switching mechanism etc. of the objective lens 8 is required, the degradation of the height measurement accuracy can be prevented by the rigidity degradation in the objective lens fixation part.

In the first embodiment, the variable diaphragm 13 is operated by the control of the computer 14, but the operation thereof may be performed manually, or by both of manual and electric operation, or by exchanging the variable diaphragm 13 for the diaphragm with the fixed diaphragm diameter. Specifically, the following modes can be exemplified.

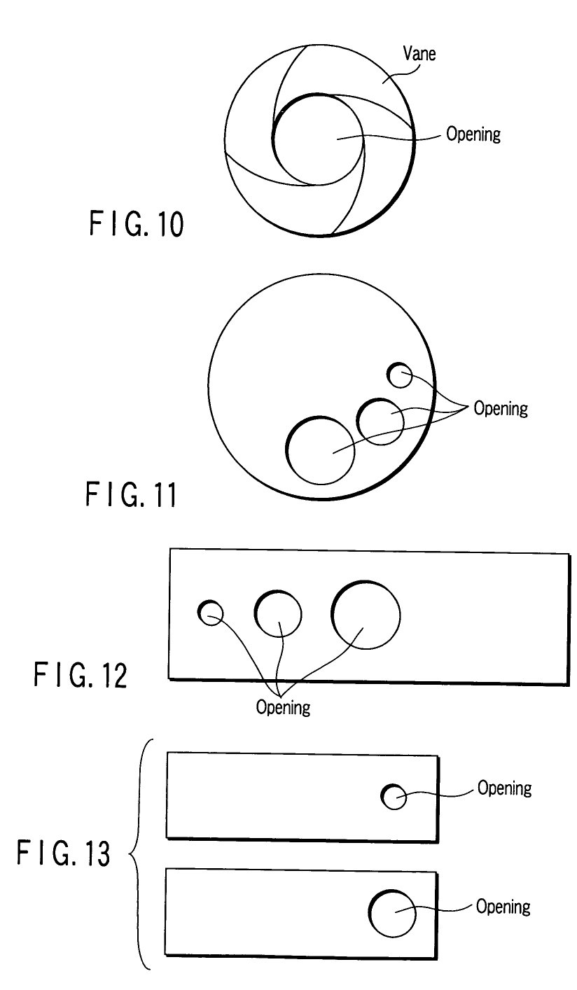

(1) The shutter with the vane-type is driven, and the diameter is changed continuously (See FIG. 10).

(2) The disk having two or more openings with different diameters is rotated to select the desired opening diameter (See FIG. 11).

(3) The plate-like material (slider) having two or more openings with different diameters is moved along the straight line to select the opening diameter of the desire (See FIG. 12).

(4) A plurality of plate-like materials (sliders) each having the opening with a different diameter is exchanged (See FIG. 13).

(Second Embodiment)

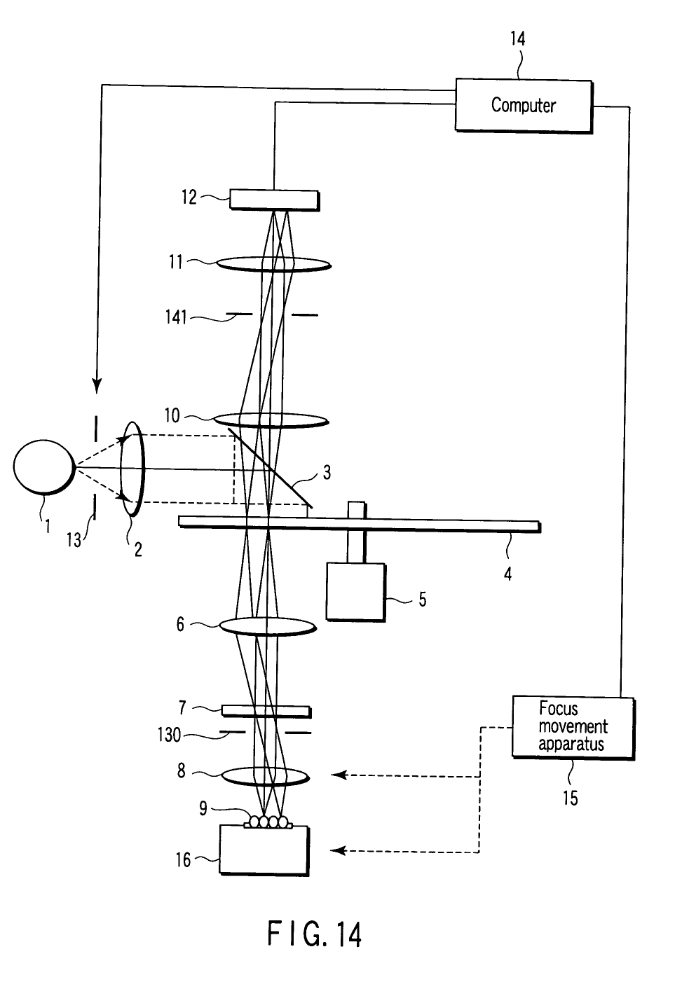

FIG. 14 is a figure which shows a schematic configuration of the second embodiment of the present invention. In FIG. 14, the same references are fixed to the same parts in FIG. 7, and a detailed explanation will be omitted.

In the second embodiment, the variable diaphragm 13 (that is, variable diaphragm) described in FIG. 7 is arranged at a front position of the light source 1, which is conjugate to the pupil position of the objective lens 8. Moreover, a fixed diaphragm 130 is arranged at the pupil position of the objective lens 8 as telecentric diaphragm. In such a configuration, the sectioning effect is determined by two of the NA of the illumination and the taken NA of the reflection light. In the second embodiment, the variable diaphragm 13 in front of the light source is varied to vary the NA of illumination, and as a result, the sectioning effect is changed.

When the diaphragm diameter of the variable diaphragm 13 is reduced, the image of the variable diaphragm 13 projected on the pupil of the objective lens 8 becomes small according to the second embodiment. As a result, the NA of the illumination light to the sample 9 becomes small. Therefore, the sectioning effect is can be changed and a similar effect to the first embodiment can be expected.

(Third Embodiment)

In the first above-mentioned embodiment and the second embodiment, an example using a usual illumination is shown, but the present invention may be applied to a case that the laser is used as an illumination.

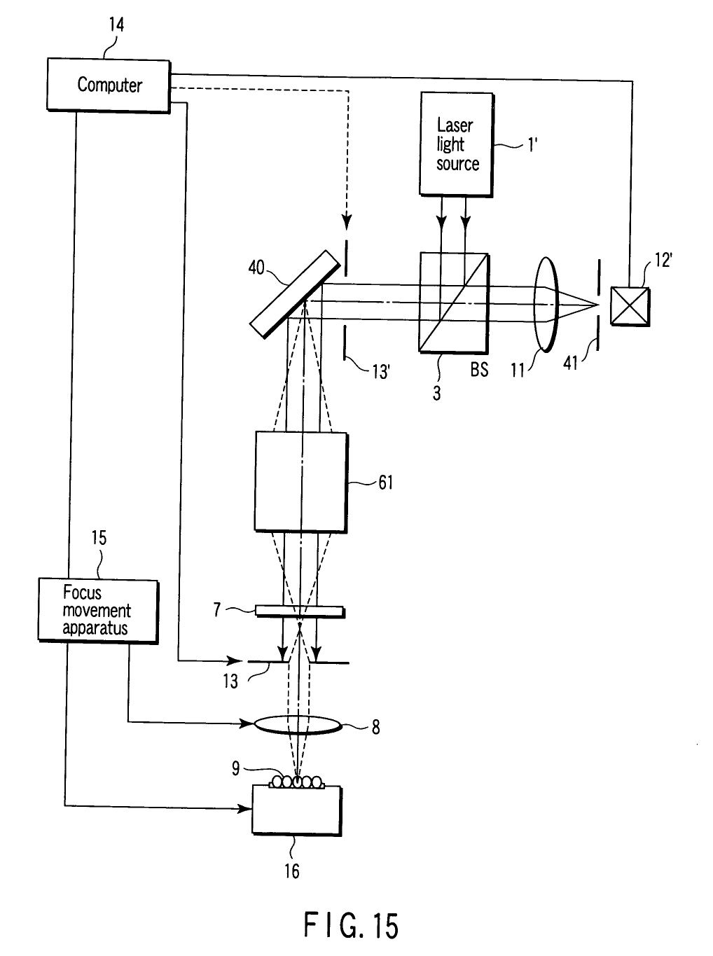

FIG. 15 is a figure which shows an example of applying present invention to the laser scanning microscope. The same references are fixed to the same parts in FIG. 7 and FIG. 14, and a detailed explanation thereof will be omitted in FIG. 15.

The light beam emitted from laser light source 1′ is incident in the two-dimensional scanning mirror 40 through the PBS 3. The light reflected with the two-dimensional scanning mirror 40 is incident to the sample 9 through the pupil projection lens 61, the ¼ wavelength plate 7, the variable diaphragm 13, and the objective lens 8. The light reflected with the sample 9 traces an optical path with opposite direction, passes the PBS 3, and is incident to the photo sensor 12′ through the lens 11 and the pinhole 41. The pinhole 41 is provided to achieve a confocal effect.

In the above-mentioned configuration, the variable diaphragm 13′ may be arranged at the pupil conjugate position (or, the neighborhood) of the objective lens 8 and between the two-dimensional scanning mirror 40 and the PBS 3 instead of the variable diaphragm 13. With this configuration, the NA can be varied by varying the variable diaphragm 13 (or 13′). Therefore, the effect same as the first embodiment and the second embodiment can be achieved in the laser scanning microscope.

(Fourth Embodiment)

In the fourth embodiment, an embodiment, which achieves an automatic focusing by using the microscope according to the first to third embodiments will be explained. Therefore, since the configuration of the apparatus is the same as the microscope according to the first to third embodiments, drawings and the explanation thereof will be omitted.

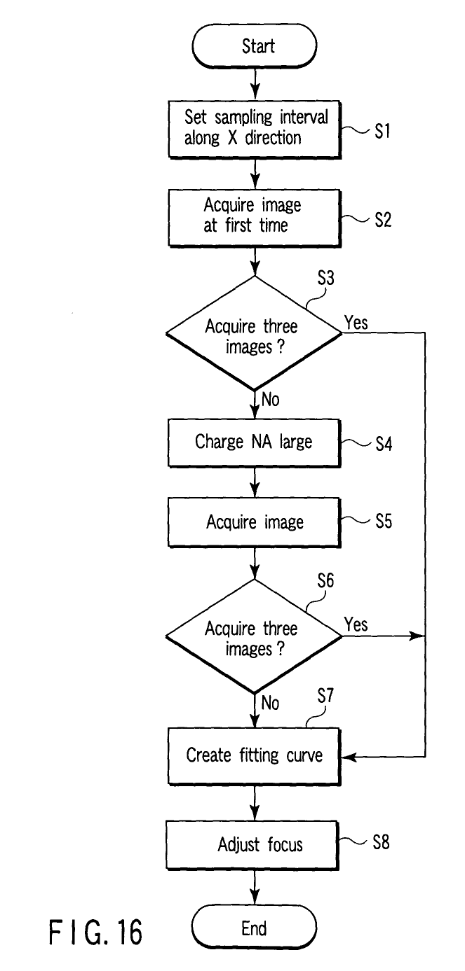

FIG. 16 is a flowchart to explain the focusing operation according to the fourth embodiment.

First, the sampling interval along the Z direction is set (step S1). For instance, this sampling interval is set based on the design data of the LSI.

Next, the image is acquired from a predetermined position (for instance, set reference position) at sampling intervals set in step S1 (step S2). If three images can be acquired in step S2 (step S3), the fitting curve is drawn based on the acquired data (step S7). Next, the focus position is obtained based on the fitting curve and the sample stage 16 or the objective lens 8 is moved along the direction of the optical axis with the focus movement apparatus 15 to adjust the focus (step S8).

For instance, when three images cannot be acquired in step S3, the NA of the objective lens 8 is reduced from NA=0.3 to NA=0.25 (step S4). As a result, since the IZ curve becomes gentle as shown in FIG. 5, more images will be obtained even in the same sampling intervals. The image is acquired again with the reduced NA (step S5). And, step S4 to step S5 are repeated until three images or more are obtained (step S6).

And, when three images or more are obtained, step S7 and step S8 are executed to adjust the focus.

In the fourth embodiment, though the focus is adjusted whether three images are acquired or not, images with the number of the images corresponding to the selected fitting curve may be acquired because the necessary number of the images changes by the fitting curve.

As shown in FIG. 6, since the part of the lower end is in a state which falls into disorder by the aberration, whether the data of the lower end part where disorder is caused by the aberration is used or not is judged and the image may be acquired by further reducing the NA when the data of the lower end part is used.

(Fifth Embodiment)

In the first embodiment and the second embodiment, the confocal disk 4 is used. And, the example, which uses the Nipkow disk on which two or more pinholes are formed spirally as the confocal disk 4 is described. In the present invention, the disk may have any patterns, which generates the sectioning effect.

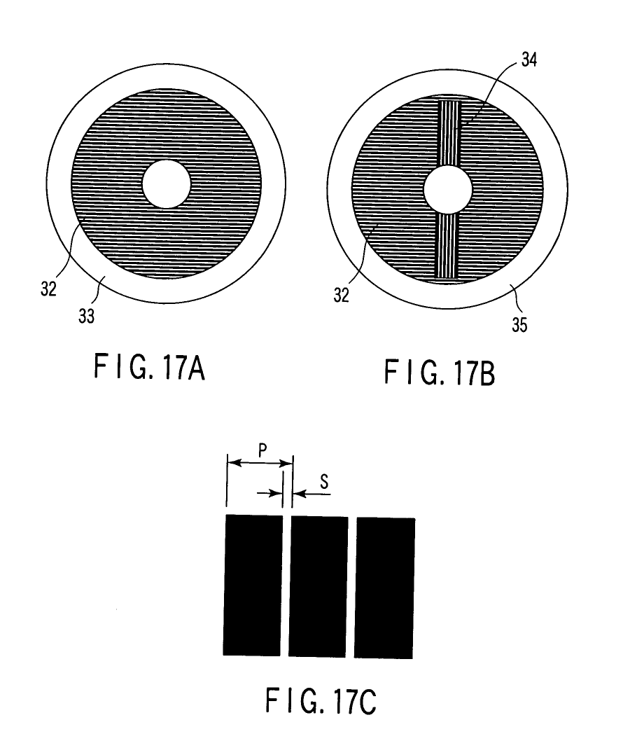

For instance, the disk 33 having periodic line pattern area 32 where a straight shielding and transmission lines shown in FIG. 17A are alternately formed can be used. The disk 35 having other line pattern areas 34 in an orthogonal direction for line pattern area 32 shown in FIG. 17B can be used.

In this case, the embodiment is characterized in that the width S of the slit of the light transmission part is ½ or less in these patterns for the pattern pitch P as shown in FIG. 17C. The slit width S is decided by emission NA′ to the disk from the tube lens 6 of the first image formation optical system and is often designed about ⅔ of the Airy disk on the disk.

Here, the ratio of the non-confocal image included in the obtained image becomes 0.5 when S/P=0.5. The ratio of the non-confocal image becomes 0.1 when S/P=0.1. The ratio of the non-confocal image similarly becomes 0.05 when S/P=0.05. As a result, a useful sectioning effect will be substantially achieved if S/P is about 0.1 or less. The ratio of the non-confocal image becomes 0.01 when S/P is 0.01, and this means a ratio obtained with above-mentioned disk is almost equal to a ratio of the non-confocal image included in the image obtained by the Nipkow disk substantially. However, since the image darkens by reducing S/P naturally, an optimal S/P may be set according to the application.

According to the disk 33 (35) having such one direction periodic line pattern area 32 (and, line pattern area 34 in an orthogonal direction), the disk 33 (35) is cheaper than the Nipkow disk because the pattern is easily formed and the disk 33 is easily manufactured, and the ratio of the optimal non-confocal image can be arbitrarily set by selecting the value of S/P according to the application.

As described above according to the present invention, an automatic focusing method which can reduce an inspection cost can be provided.

What is claimed is:

1. An automatic focusing method comprising:
scanning light from a light source which passes a confocal pattern on a sample through an objective lens while relatively moving one of the sample and the objective lens along a direction of an optical axis;
acquiring two or more sectioning images by converting the light from the sample which penetrates the confocal pattern through the objective lens by photoelectric conversion means; and
changing an opening diameter of the variable diaphragm arranged at the pupil position of the objective lens or a conjugated position to the pupil position thereof to reduce a NA of the objective lens when focusing is not obtained and repeating an operation of taking two or more sectioning images by the photoelectric conversion means and obtaining the focusing position.

2. An automatic focusing method comprising:
scanning the sample with light from a light source which passed a confocal pattern while moving one of a sample and an objective lens along the direction of an optical axis at a predetermined sampling interval;
acquiring two or more sectioning images by converting light from the sample which penetrates the confocal pattern through the objective lens by the photoelectric conversion means;
obtaining a focusing position according to a predetermined function based on the plurality of sectioning images taken by the photoelectric conversion means; and
changing an opening diameter of the variable diaphragm arranged at the pupil position of the objective lens or a conjugated position to the pupil position thereof to reduce a NA of the objective lens when focusing is not obtained and repeating an operation of taking two or more sectioning images by the photoelectric conversion means and obtaining the focusing position.

3. The automatic focusing method according to claim 2, wherein an objective lens with low magnification and high NA is used for the objective lens.

4. The automatic focusing method according to claim 2, wherein two or more sectioning images are taken without changing the predetermined sampling interval when the NA of the objective lens is changed.

5. The automatic focusing method according to claim 2, wherein an operation to which the focusing position is obtained is repeated until three or more sectioning images are acquired.

6. The automatic focusing method according to claim 2, wherein whether the sectioning image uses data of a part where disorder is caused by an aberration of the objective lens is judged and the sectioning image is acquired by reducing the NA of the objective lens when the disordered data is used.
